(19) United States
(12) Patent Application Publication
(10) Pub. No.: US 2021/0344664 A1
(43) Pub. Date: Nov. 4, 2021

(54) Methods, Systems, and Electronic Devices for Selective Locational Preclusion of Access to Content

(71) Applicant: Motorola Mobility LLC, Chicago, IL (US)

(72) Inventors: Rachid Alameh, Crystal Lake, IL (US); Jarrett Simerson, Glenview, IL (US)

(21) Appl. No.: 16/861,934

(22) Filed: Apr. 29, 2020

(51) Int. Cl. H04L 29/06

(52) U.S. Cl. CPC H04L 63/083; H04L 63/0876; H04L 63/20; H04L 63/102; H04L 63/107

(57) ABSTRACT

An electronic device includes a user interface receiving user credentials, a location detector determining a location of the electronic device when the user credentials are received, and one or more processors determining whether the user credentials are administrative user credentials. When the user credentials are other than the administrative user credentials, the one or more processors make content created in the electronic device within a predefined radius of the location accessible and preclude access to other content created in the electronic device outside the predefined radius of the location.

### BACKGROUND

### Technical Field

This disclosure relates generally to electronic devices, and more particularly to electronic devices with location detectors.

### Background Art

Portable electronic devices, such as smartphones, tablet computers, laptop computers, and so forth are continually becoming more advanced. The processing power available in the modern smartphone exceeds that of the most powerful workstations of the past. With this increased processing power, users are performing more, and more sophisticated, tasks using only a smartphone or tablet computer. For example, some users eschew a desktop or laptop computer, instead performing financial transactions, budgeting, calendaring, health monitoring, and other tasks using only a smartphone.

With all of the computational features available for such modern electronic devices, there can be a need to control access to different types of locations. For example, in an enterprise context it may be desirable to limit what content a particular user may access. It would be advantageous to have improved electronic devices, systems, and methods facilitating the same.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device configured in accordance with one or more embodiments of the disclosure.

FIG. 3 illustrates another explanatory method in accordance with one or more embodiments of the disclosure.

FIG. 4 illustrates one explanatory system and method in accordance with one or more embodiments of the disclosure.

FIG. 5 illustrates another explanatory method in accordance with one or more embodiments of the disclosure.

FIG. 6 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to making accessible, with one or more processors, a first content set comprising content created or stored in a memory of an electronic device within a predefined radius of a login location for a user logging in with less than administrative credentials, and precluding access to a second content set comprising content created or stored in the memory of the electronic device outside the predefined radius of the login location. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of making only content created or stored within the electronic device within a predefined radius of a location at which a user logs in with less than administrative credentials and precluding access to other content created or stored within the electronic device outside the predefined radius of this location as described herein. The non-processor circuits may include, but are not limited to, a radio receiver, a radio transmitter, signal drivers, clock circuits, power source circuits, and user input devices.

As such, these functions may be interpreted as steps of a method to perform the steps of making accessible, by one or more processors of an electronic device, only content created or stored in the memory of an electronic device within a predefined radius of the location of the electronic device at which user credentials allowing less than administrative access to the electronic device are entered. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially”, “essentially”, “approximately”, “about” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide electronic devices, methods, and systems that control content viewability and protect content privacy based upon a content capture location, user location, and device access level. In one or more embodiments, based upon the combination of these three factors, the visibility, viewability, and sharing of content is restricted by default to enhance data security and user privacy. The methods, systems, and devices described herein are useful in an enterprise setting to, for example, allow users to access work content while at work, and personal content while at home, all on the same device without cross-contamination of the two. Advantageously, the methods, devices, and systems can prevent confidential work information from being exposed at home, for example, as well as to prevent controversial personal information from being exposed at work.

In one or more embodiments, access to an electronic device occurs at two different levels. The first is an administrative access level, in which all content stored or created in the electronic device is fully accessible, viewable, and/or sharable. The second level is less than the administrative access level, where there are at least some restrictions regarding what content can be accessed, viewed, or retrieved. While the amount of restrictions can vary, and while the “less than administrative access level” can comprise a plurality of sub-levels with varying amounts of content restrictions, this collective second level can be referred to as a “user access level,” with the credentials required to access one of these user access levels being referred to as “user login credentials.” Accordingly, user login credentials offer less access to content stored in, or accessible by, the electronic device than do administrative login credentials in one or more embodiments.

In one or more embodiments, if a user logs on with less than administrative access credentials, access to content, which may include applications operable on one or more processors of the electronic device, files stored in the memory of the electronic device, files accessible from a cloud server by the one or more processors, data stored within the memory of the electronic device, data that is accessible from a cloud server, media content stored locally or in a cloud server, (e.g., pictures, songs, videos, sound recordings, movies, text messages, multimedia messages, and so forth), backups, social media content, or other content, is limited. In one or more embodiments, the limitations of access are a function of the content creation location and the location of the user, either when entering the login credentials or when actively using the electronic device. The limitations associated with users who are not administrative access level users can include making certain content visible but inaccessible, making certain content invisible, or implementing other restrictions that preclude access and or use of content of the electronic device.

Accordingly, using embodiments of the disclosure, data collected at work, optionally during work hours, can be shared when the user of the electronic device (who is not an administrator) is at work. However, if the user leaves work and goes to a restaurant, that data, which may include confidential and proprietary work information, becomes inaccessible or invisible and/or not sharable without administrative credentials. However, when the user returns to work, the work data again becomes visible and/or accessible, even with the less than administrative access that the user possesses. In one or more embodiments, in addition to limiting access to the content as a function of the login location, visibility of content can be altered. For example, certain user icons or actuation targets may be removed or hidden so as to be unable to be seen.

In one or more embodiments access to content in an electronic device depends upon three factors: where the content was captured, created, and/or stored within the electronic device, a location where login credentials are entered or where the electronic device is actively being used, are device data being accessed, and the access level of the user operating the electronic device. For example, in one explanatory method a user interface of an electronic device receives user login credentials. A location detector of the electronic device identifies a login location of the electronic device occurring when the user login credentials are received.

In one or more embodiments, one or more processors operable with the user interface and the location detector determine whether the user login credentials are administrative login credentials or user login credentials. In one or more embodiments, when the user login credentials are determined to be user login credentials, rather than administrative login credentials, one or more processors of the electronic device make accessible a first content set comprising content created or stored in a memory of the electronic device within a predefined radius of the login location. At the same time, in one or more embodiments the one or more processors preclude access to a second content set comprising content created or stored in the memory of the electronic device outside the predefined radius of the login location. This preclusion can comprise concealing or locking one or more user actuation targets in one or more embodiments. In other embodiments, the preclusion can comprise disabling one or more user actuation targets. In one or more embodiments, the first content set and the second content set are user definable using one or more control settings of the electronic device.

Since the location of the user using the electronic device can change, in one or more embodiments, the location detector monitors an operating location of the electronic device while the user login credentials are active. Such a condition can occur for a variety of reasons. For instance, in a primary embodiment, the electronic device will be operational with the user login credentials remaining active after the user has logged into the electronic device so long as the electronic device remains unlocked. In another embodiment, the electronic device could be operational with the user login credentials being active when the user login credentials are present by an administrative user and/or permanently stored in the electronic device such that no login action is required. An administrative user, for example, may allow the electronic device to be operational using user login credentials without requiring an active login event, while requiring a login event with administrative login credentials for administrative access. Other instances of situations in which the electronic device is operational with active user login credentials will be obvious to those of ordinary skill in the art having the benefit of this disclosure.

When the location detector determines that the electronic device, while the user login credentials are active, regardless of why the user login credentials are active, moves outside the predefined radius, the process can be repeated. For example, when the operating location moves outside the predefined radius the one or more processors can make a third content set comprising content created or stored in the memory of the electronic device within another predefined radius of the operating location. At the same time, the one or more processors cam preclude access to a fourth content set comprising content created or stored in the memory of the electronic device outside the predefined radius of the operating location. Accordingly, the electronic device can monitor the operating location to continually make different content accessible while precluding access to other content as a function of the current location and the location at which the content was created or stored.

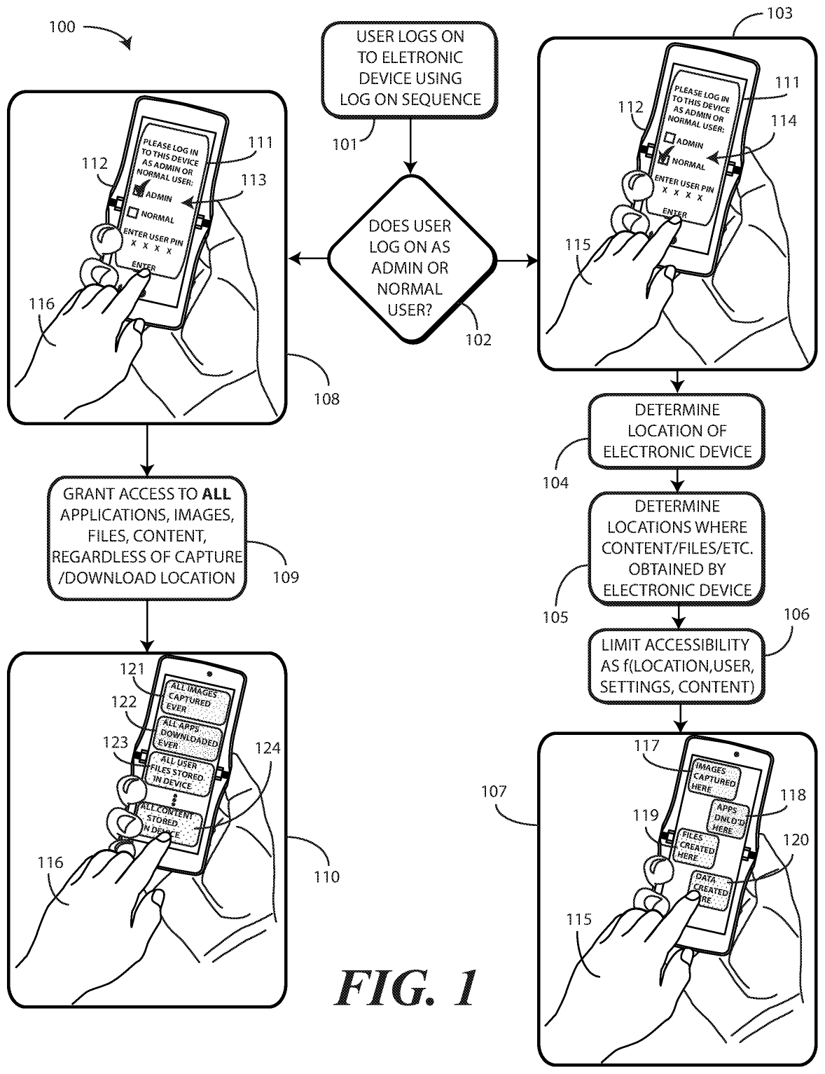

Turning now to FIG. 1, illustrated therein is one explanatory method 100 in accordance with one or more embodiments of the disclosure. Beginning at step 101, a user initiates a login operation at an electronic device. Decision 102 then determines whether the user has administrative access or less than administrative access.

For example, as shown at step 108, a user interface 111 of an electronic device 112 receives user login credentials 113. At step 108, the user login credentials 113 are administrative login credentials. By contrast, at step 103, where the user interface 111 of the electronic device 112 also receives user login credentials 114, the user login credentials 114 entered are other than administrative login credentials. As used herein, “administrative login credentials” is the highest level of access an electronic device can have. A user with administrative login credentials can access any content, file, data, application, or other feature of the electronic device. However, anything other than administrative login credentials, e.g., regular user login credentials, come with at least one limitation regarding content, files, data, applications, or other information that can be accessed via the user interface 111. Accordingly, as used herein any user credentials that are not administrative login credentials are subsidiary or subordinate credentials offering less access to filed, content, data, applications, or feature of the electronic device.

As noted above, in another embodiment, the electronic device 112 could be configured such that during ordinary use no subsequent login event is required. In an enterprise situation, for example, an administrative user may enter user login credentials 114 that are not administrative login credentials at step 101. Thereafter, anyone may be able to access the device with the less than administrative credentials without a new login event. Accordingly, the method 100 would proceed from step 101, through decision 10, straight to step 104, bypassing step 103 in such an embodiment.

At step 103, the user interface 111 receives user login credentials 114. However, the user login credentials 114 are not administrative login credentials. They are instead other than administrative login credentials, i.e., user credentials allowing less than administrative access to the electronic device 112. One or more processors of the electronic device 112 identify the fact that the user login credentials 114 entered are other than administrative login credentials.

At step 104, a location detector of the electronic device 112 identifies a login location of the electronic device 112 occurring when the user login credentials 114 are received at step 103. For example, if the user 115 of the electronic device 112 is at work, the location detector of the electronic device 112 will identify this location at step 104. By contrast, if the user 115 is in a restaurant, bar, grocery store, or at home when entering the user login credentials 114, the location detector of the electronic device 112 will determine this at step 104 as well.

Since the user login credentials 114 entered at step 103 are not administrative login credentials, at step 106 the one or more processors limit access to content in the electronic device 112 at step 106 based upon a location where the content was created, downloaded, installed, or stored, as determined at step 105. In one or more embodiments, the limitations to access to content are a function of the location where the user login credentials 114 were received or the location of the electronic device 112 while the user login credentials 114 are active if the electronic device 112 has moved from the login location, user defined settings, and the location where the content was created or stored in the memory of the electronic device 112.

For example, in one or more embodiments step 106 comprises the one or more processors of the electronic device 112 making accessible a first content set and precluding access to a second content set. In one or more embodiments, the first content set comprises content created at the electronic device 112 or stored in a memory of the electronic device 112 within a predefined radius of the location where the user login credentials 114 were received at step 104, which is referred to as the “login location.” The memory may be physically situated within the electronic device 112, partially situated within the electronic device 112, or stored elsewhere, such as in a cloud server. In one or more embodiments, the second content set comprises content created at the electronic device 112 or stored in a memory of the electronic device 112 outside the predefined radius of the login location.

Accordingly, if the login location is a user's work place, and one or more device settings define the predefined radius to be one half mile, any content created at the electronic device 112, stored within the electronic device 112, or stored in another electronic device, e.g., a cloud server, by the electronic device 112 within a half-mile radius of the login location will be accessible. However, content created at the electronic device 112, stored within the electronic device 112, or stored in another electronic device by the electronic device 112 outside the half-mile radius of the login location will be precluded from access. Thus, a spreadsheet created at work using the electronic device 112 and stored in a cloud server while the user 115 was at work will be accessible, while pictures and videos captured at home (presuming the user 115 lives more than a half mile from work) will be precluded from being accessed. This preclusion can include concealing icons or user actuation targets linked to the content, thereby rendering them invisible in one or more embodiments. In other embodiments, icons, user actuation targets linked to the content, or other access points for the content created or stored in the memory of the electronic device 112 will simply be deactivated.

As used herein, “content,” in the context of making content accessible, precluding access to content, or the “stuff” present in any of a first content set, second content set, third content set, fourth content set, and so forth, refers to a variety of information that is electronically accessible by the one or more processors of the electronic device 112. For example, “content” can include applications operable on the one or more processors of the electronic device 112, media content accessible at the user interface 111 of the electronic device 112, whether stored in the electronic device 112 or in another device such as a cloud server, files stored within the memory of the electronic device 112, files stored outside the electronic device 112, e.g., in a cloud server, which were stored using the electronic device 112, data stored within the memory of the electronic device 112, data stored outside the electronic device 112 in another electronic device that were stored using the electronic device 112, media content, e.g., pictures, videos, sounds, screenshots, etc., which were captured by the electronic device 112, social media content stored within the memory of the electronic device 112 or that is accessible from a cloud server, features of the electronic device 112, or combinations thereof. Other examples of content will be obvious to those of ordinary skill in the art having the benefit of this disclosure.

Moreover, as used herein a content “set” refers to a subset of content of the electronic device 112. Accordingly, a “first content set” would define a first subset of all of the content available at the electronic device 112, while a “second content set” would find a second, different content set from the first content set. Where a first content set is accessible and a second content set is precluded from access, these respective content sets are non-overlapping. By contrast, when a first content set is accessible within a predefined radius of a first location, and a third content set is accessible within a predefined radius of a second location, these content sets can overlap when the predefined radii are intersect as they extend from the first location and the second location, respectively.

In contrast to the limited access to content provided by the user login credentials 114 entered at step 103, at step 108 another user 116 enters user login credentials 113 comprising administrative login credentials. Accordingly, at step 109 the one or more processors of the electronic device 112 make accessible all content available to the electronic device 112. If step 106 makes the first content set accessible to user 115 while precluding access to the second content set, step 109 would make both the first content set and the second content set accessible to user 116 due to the fact that the user login credentials 113 entered at step 109 are administrative login credentials.

This distinction can be seen by comparing step 107 and step 110. At step 107, user 115 only has access to media content 117 created or stored by, or within, the electronic device 112 within the predefined radius of the login location, applications 118 created or stored by, or within, the electronic device 112 within the predefined radius of the login location, files 119 created or stored by, or within, the electronic device 112 within the predefined radius of the login location, and data 120 created or stored by, or within, the electronic device 112 within the predefined radius of the login location. User 115 is precluded from accessing media content created or stored by, or within, the electronic device 112 outside or beyond the predefined radius of the login location, applications created or stored by, or within, the electronic device 112 outside or beyond the predefined radius of the login location, files created or stored by, or within, the electronic device 112 outside or beyond the predefined radius of the login location, and data created or stored by, or within, the electronic device 112 outside or beyond the predefined radius of the login location.

By contrast, at step 110, user 116 has access to all media content 121 created or stored by, or within, the electronic device 112 at any location, applications 122 created or stored by, or within, the electronic device 112 at any location, files 123 created or stored by, or within, the electronic device 112 at any location, and data 120 created or stored by, or within, the electronic device 112 at any location due to the fact that user 116 entered administrative login credentials at step 108. Thus, at step 110 the one or more processors of the electronic device 112 make accessible both the first content set and the second content set, while user 115 has access to only the first content set at step 107 due to the fact that access to the second content set is precluded at step 107.

Using the method 100 of FIG. 1, user 115 is at work, data 120 captured by the electronic device 112 is accessible, can be viewed, manipulated, and shared while the user 115 is at work. However, if the user 115 leaves work and goes to a restraint, these data 120, which may be work-sensitive, are no longer available, accessible, and/or viewable. When the user 115 returns to work, these data 120 will once again be made available. By contrast, at step 110 user 116 has continual access to all content due to the fact that the user login credentials 114 entered at step 108 were administrative login credentials.

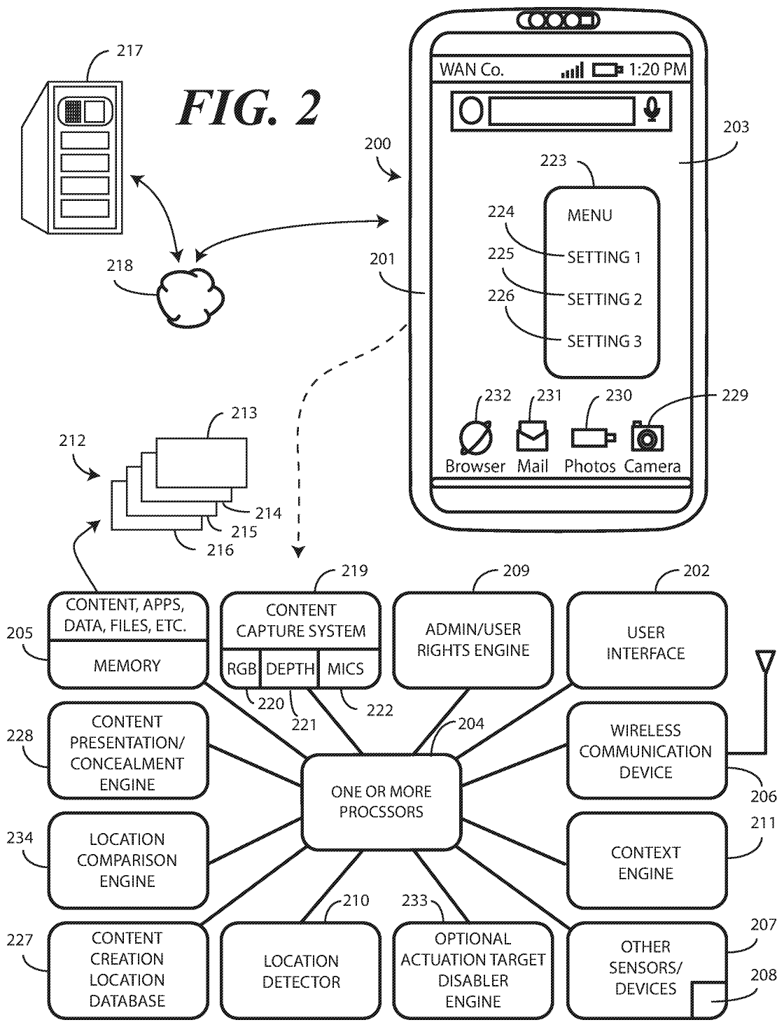

Turning now to FIG. 2, illustrated therein is one explanatory electronic device 200 configured in accordance with one or more embodiments of the disclosure. Also illustrated in FIG. 2 is schematic block diagram for the electronic device. It should be noted that the electronic device 200, while shown as a smartphone for illustrative purposes in FIG. 2, can be any of a number of various types of devices. It will be obvious to those of ordinary skill in the art having the benefit of this disclosure that the block diagram schematic of FIG. 2 could be adapted for use with other devices as well, including conventional desktop computers, palm-top computers, tablet computers, gaming devices, media players, wearable devices, or other devices.

In one or more embodiments, the components of the block diagram schematic are configured as a printed circuit board assembly disposed within a housing 201 of the electronic device 200. Various components can be electrically coupled together by conductors or a bus disposed along one or more printed circuit boards.

The illustrative block diagram schematic of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic includes a user interface 202. In one or more embodiments, the user interface 202 includes a display 203. Where included, the display 203 may optionally be touch-sensitive. In one or more embodiments, users can deliver user input to the display 203 of such an embodiment by delivering touch input from a finger, stylus, or other objects disposed proximately with the display 203. In one embodiment, the display 203 is configured as an active matrix organic light emitting diode (AMOLED) display. However, it should be noted that other types of displays, including liquid crystal displays, suitable for use with the user interface 202 would be obvious to those of ordinary skill in the art having the benefit of this disclosure.

In one embodiment, the electronic device includes one or more processors 204. The one or more processors 204 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic. Each of the application processor and the auxiliary processor(s) can be configured to process and execute executable software code to perform the various functions of the electronic device with which the block diagram schematic operates. A storage device, such as memory 205, can optionally store the executable software code used by the one or more processors 204 during operation.

Content 212 created in, received by, or obtained by the one or more processors 204 can be stored in the memory 205. As previously described, this content can include applications 213 operable on the one or more processors 204, media content 214 accessible at the user interface 202 of the electronic device 200, files 215 stored within the memory 205 of the electronic device 200, data 216 stored within the memory 205 of the electronic device 200, or combinations thereof. The content 212 may be stored outside of the electronic device 200 as well, such as in a cloud server 217 across a network 218. The content 212 may be stored partially in the memory 205 and partially in an external device, such as cloud server 217 or a jump drive, as well.

As noted above, the content 212 can include applications 213 operable on the one or more processors 204 of the electronic device 200, media content 214 accessible at the user interface 202 of the electronic device 200, whether stored in the electronic device 200, in the cloud server 217, or in another device, files 215 stored within the memory 205 of the electronic device 200, files stored outside the electronic device 200, e.g., in the cloud server 217, which were stored using the electronic device 200, data 216 stored within the memory 205 of the electronic device 200, data stored outside the electronic device 200 in another electronic device that were stored using the electronic device 200, media content 214, e.g., pictures, videos, sounds, screenshots, etc., which were captured by a media content capture system 219 of the electronic device 200, social media content stored within the memory 205 of the electronic device 200 or that is accessible from a cloud server 217, features of the electronic device 200, or combinations thereof. Other examples of content 212 will be obvious to those of ordinary skill in the art having the benefit of this disclosure.

In this illustrative embodiment, the block diagram schematic also includes a communication device 206 that can be configured for wired or wireless communication with one or more other devices or networks. The networks can include a wide area network, a local area network, and/or personal area network. The communication device 206 may also utilize wireless technology for communication, such as, but are not limited to, peer-to-peer or ad hoc communications such as HomeRF, Bluetooth, and IEEE 802.11, as well as other forms of wireless communication such as infrared technology. The communication device 206 can include wireless communication circuitry, one of a receiver, a transmitter, or transceiver, and one or more antennas.

In one embodiment, the one or more processors 204 can be responsible for performing the primary functions of the electronic device with which the block diagram schematic is operational. For example, in one embodiment the one or more processors 204 comprise one or more circuits operable with the user interface 202 to present presentation information to a user. The executable software code used by the one or more processors 204 can be configured as one or more modules that are operable with the one or more processors 204. Such modules can store instructions, control algorithms, and so forth.

An authentication system 209 can be configured to receive user login credentials and determine whether the user login credentials are administrative login credentials or other than administrative login credentials. Said differently, the authentication system 209 can determine whether received user credentials are administrative user credentials, which allow administrative access to the electronic device 200, or other user credentials allowing less than administrative access to the electronic device 200.

The user login credentials processed by the authentication system 209 can take a variety of forms. For example, the user login credentials can be in the form of a personal identification (PIN) or password. While this form of user login credential works well, it requires a user to manually enter these user login credentials at the user interface 202. In other embodiments, rather than requiring a user to enter the user login credentials manually, the authentication system 209 of the electronic device 200 can passively obtain the user login credentials, such as by capturing one or more images of the user, one or more facial depth scans of the user, an iris scan of the user, a fingerprint of the user, a retina scan of the user, a voice sample, or other biometric information. Consequently, in one or more embodiments the authentication system 209 can be configured to passively obtain the user login credentials from the user.

In one or more embodiments, the block diagram schematic includes one or more sensors 207. The one or more sensors 207 can each be operable with an input/processor 208. For example, of the one or more sensors 207 comprise an audio input, the one or more input/processors 208 can include an audio input/processor 208. The audio input/processor can include hardware, executable code, and speech monitor executable code in one embodiment. The audio input/processor can include, stored in memory 205, basic speech models, trained speech models, or other modules that are used by the audio input/processor to receive and identify voice commands that are received with audio input captured by an audio capture device. In one embodiment, the audio input/processor can include a voice recognition engine. Regardless of the specific implementation utilized in the various embodiments, the audio input/processor can access various speech models to identify speech commands. In one embodiment, the audio input/processor is configured to implement a voice control feature that allows a user to speak a specific device command to cause the one or more processors 204 to execute a control operation.

In one or more embodiments, the electronic device 200 includes a location detector 210. In one embodiment, location detector 210 is able to determine location data when the electronic device 112 captures user login credentials, an operating location of the electronic device 200 when the user login credentials are active, or location data when other operations occur with the electronic device 200.

In one or more embodiments, the location data captured by the location detector 210 can also be tagged to content captured or stored by the electronic device 20. This location data can be captured in a variety of ways, including by capturing the location data from a constellation of one or more earth orbiting satellites, or from a network of terrestrial base stations to determine an approximate location. In one or more embodiments, the satellite positioning systems based location fixes of the location detector 210 autonomously or with assistance from terrestrial base stations, for example those associated with a cellular communication network or other ground based network, or as part of a Differential Global Positioning System (DGPS), as is well known by those having ordinary skill in the art. The location detector 210 may also be able to determine location by locating or triangulating terrestrial base stations of a traditional cellular network, or from other local area networks, such as Wi-Fi networks.

A context engine 211 can be operable with the one or more sensors 207 to detect, infer, capture, and otherwise determine persons and actions that are occurring in an environment about the electronic device 200. For example, where included one embodiment of the context engine 211 determines assessed contexts and frameworks using adjustable algorithms of context assessment employing information, data, and events. These assessments may be learned through repetitive data analysis. These assessments can be used to obtain additional authorization to transmit media content in one or more embodiments. Alternatively, a user may employ the user interface 202 to enter various parameters, constructs, rules, and/or paradigms that instruct or otherwise guide the context engine 211 in detecting multi-modal social cues, emotional states, moods, and other contextual information that can be used as additional authorization to transmit media content in response to a prompt by the one or more processors 204. The context engine 211 can comprise an artificial neural network or other similar technology in one or more embodiments.

In one or more embodiments, the context engine 211 is operable with the one or more processors 204. In some embodiments, the one or more processors 204 can control the context engine 211. In other embodiments, the context engine 211 can operate independently, delivering information gleaned from detecting multi-modal social cues, emotional states, moods, and other contextual information to the one or more processors 204. The context engine 211 can receive data from the various sensors. In one or more embodiments, the one or more processors 204 are configured to perform the operations of the context engine 211.

A media content capture system 219 can capture media content from an environment of the electronic device 200. In one or more embodiments, the media content capture system 219 comprises an imager 220. The media content capture system 219 can also include an optional depth imager 221 and/or one or more microphones 222.

In one or more embodiments, the media content capture system 219 includes a face analyzer and/or an environmental analyzer. The face analyzer and/or environmental analyzer can be configured to process an image or depth scan of an object and determine whether the object matches predetermined criteria. For example, media content capture system 219 can operate as an identification module configured with optical and/or spatial recognition to identify objects using image recognition, character recognition, visual recognition, facial recognition, color recognition, shape recognition, and the like. Advantageously, the media content capture system 219, operating in tandem with the authentication system 209, can be used as a facial recognition device to receive user login credentials in the form of biometric input.

The one or more processors 204 of the electronic device 200 can optionally present a menu 223 with one or more control settings 224,225,226 that allow a user possessing administrative login credentials to define what content is made accessible and what content is precluded from access when other users having less than administrative login credentials access the electronic device 200. For example, as described above with reference to FIG. 1, in one or more embodiments the one or more processors 204 can make a first content set comprising content created or stored in the memory 205 of the electronic device 200 within a predefined radius of a particular location accessible, while precluding access to a second content set comprising content created or stored in the memory 205 of the electronic device 200 outside the predefined radius of the location. In one or more embodiments, the types of content included in one or both of the first content set or the second content set are user definable using the one or more control settings 224, 225,226 of the menu 223 presented on the display 203. For example, in an enterprise situation, an implementer of a distributed system may not be concerned about applications created or stored in the memory 205 of the electronic device 200 outside the predefined radius of the location being accessed while the electronic device 200 is within the predefined radius, but may not want media content, e.g., pictures, videos, and sounds, created or stored in the memory 205 of the electronic device 200 outside the predefined radius of the location to be accessed within the predefined radius. Accordingly, the one or more control settings 224,225,226 would allow the types of content included in one or both of the first content set or the second content set to be user definable. The one or more control settings 224,225,226 can also be used to define other parameters, including the predefined radius used in allowing/precluding access as well.

Where the content 212 is created or stored in the memory 205 of the electronic device 200 can be stored within a content creation location database 227. For example, when a user employs the user interface 202 to download an application and store it in the memory 205, in the cloud server 217, or in another electronic device, the location at which this occurs can be recorded in the content creation location database 227. Similarly, the location at which a user employs the user interface 202 to enter data into a spreadsheet or word processing application can be recorded in the content creation location database 227. The locations where the imager 220 captures images can be recorded in the content creation location database 227, and so forth. When determining whether content 212 was created in, or stored by, the electronic device 200, the one or more processors 204 can consult the content creation location database 227 in conjunction with location data received from the location detector 210 to make such a determination.

When the one or more processors 204 preclude access to a subset of the content 212 as a function of the user login credentials, the location where the user login credentials are entered or the location of the electronic device 200 when the user login credentials are active, and the location where the content 212 was created in, or stored by, the electronic device 200, this can occur in multiple ways. In one or more embodiments, a content presentation/concealment engine 228 can present user actuation targets 229,230,231,232 linking to the content 212 on the user interface 202 of the electronic device 200 when making this content 212 accessible. By contrast, when precluding access to the content 212, the content presentation/concealment engine 228 can conceal the user actuation targets 229,230,231,232 linking to the content 212 when precluding access thereto. The content presentation/concealment engine 228 can conceal the user actuation targets 229,230,231,232 linking to the content 212 in a variety of ways, such as greying the user actuation targets 229,230,231,232 linking to the content 212, blurring the user actuation targets 229,230,231,232 linking to the content 212, or by other techniques.

In other embodiments, an actuation target disabler engine 233 can make the user actuation targets 229,230,231,232 linking to the content 212 active when making the content accessible at the user interface 202 of the electronic device 200. Rather than concealing the user actuation targets 229,230,231,232 linking to the content 212 when precluding access thereto, thus making the user actuation targets 229,230,231,232 linking to the content 212 invisible, the actuation target disabler engine 233 disables the user actuation targets 229,230,231,232 linking to the content 212.

Accordingly, in one or more embodiments precluding access to, for example, a second content set comprises the content presentation/concealment engine 228 concealing the user actuation targets 229,230,231,232 linking to the content 212. In other embodiments, precluding access to a set of content comprises the actuation target disabler engine 233 disabling the user actuation targets 229,230,231,232 linking to the content 212. Other techniques for precluding access to the user actuation targets 229,230,231,232 linking to the content 212 will be obvious to those of ordinary skill in the art having the benefit of this disclosure.

Embodiments of the disclosure contemplate that the electronic device 200 may move while the user login credentials are active. The location detector 210 is operable, in conjunction with the one or more processors 204, to monitor such movement. A location comparison engine 234 can compare, for example, the login location to an operating location of the electronic device 200 where the electronic device is operating with the user login credentials remaining active. In one or more embodiments, when the location comparison engine 234 determines that the operating location is beyond the predefined radius from the login location, in one or more embodiments the one or more processors 204 make a third content set comprising content created or stored in the memory 205 of the electronic device 200 within another predefined radius of the operating location accessible. The one or more processors 204 then preclude access to a fourth content set comprising content created or stored in the memory 205 of the electronic device outside the other predefined radius of the operating location, and so forth. In so doing, the location comparison engine 234 is able to continually determine when the electronic device 200 moves, thereby allowing the one or more processors 204 to make new content accessible and preclude other content as a function of the operating location of the electronic device 200.

Accordingly, as shown and described with reference to FIG. 2, a user interface 202 is operable to receive user login credentials. A location detector 210 is operable to determine a location of the electronic device 200 when the user login credentials are received. One or more processors 204, using an authentication system 209, determine whether the user login credentials are administrative user credentials or, alternatively, whether the user login credentials allow less than administrative access to the electronic device 200.

Where the user login credentials are other than the administrative user credentials, in one or more embodiments the one or more processors make content created in the electronic device 200 within a predefined radius of the location determined by the location detector 210 accessible. However, the one or more processors preclude access to other content created in the electronic device 200 outside the predefined radius of the location. The one or more processors 204 preclude access to the other content by causing the content presentation/concealment engine 228 to conceal user actuation targets 229,230,231,232 linking to the precluded content. The one or more processors 204 can make the other content accessible by causing the content presentation/concealment engine 228 to reveal user actuation targets 229,230,231,232 linking to the accessible content.

Alternatively, the one or more processors 204 can preclude access to the other content by causing the actuation target disabler engine 233 to disable the user actuation targets 229,230,231,232 linking to the precluded content. The one or more processors 204 can also preclude access to the other content by causing the actuation target disabler engine 233 to lock the user actuation targets 229,230,231,232 linking to the precluded content. The one or more processors 204 can make other content accessible by causing the actuation target disabler engine 233 to enable the user actuation targets 229,230,231,232 linking to the accessible content, and so forth. Using the location comparison engine 234, the one or more processors 204 can continually alter which content is accessible and which content is precluded from access as a function of location when the location of the electronic device 200 changes. It should be noted that when administrative user credentials are entered at the user interface 202, the one or more processors 204 make all content accessible without any preclusion.

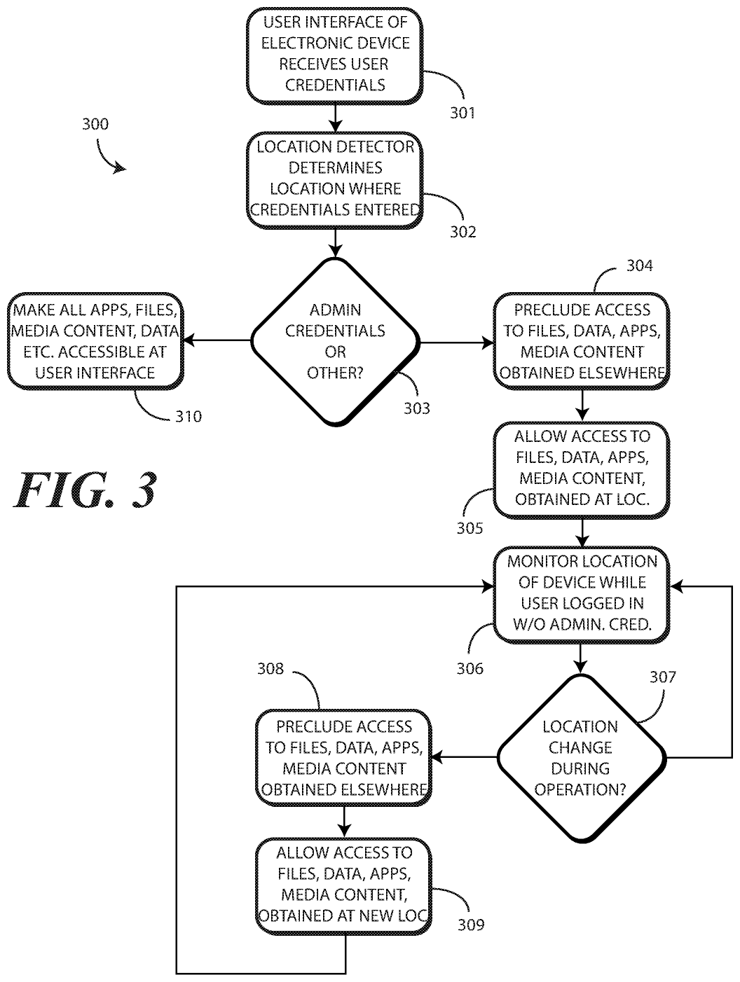

Turning now to FIG. 3, illustrated therein is one explanatory method 300 for using the electronic device (200) of FIG. 2. Beginning at step 301, a user interface (202) of the electronic device (200) receives user credentials. In one or more embodiments, the user credentials comprise user login credentials. As noted above, the user login credentials can comprise administrative login credentials or administrative user credentials, which allow full access to the content (212) of the electronic device (200) at step 310. By contrast, the user login credentials received at the user interface (202) of the electronic device (200) at step 301 can allow less than administrative access to the electronic device (200). Whether the user login credentials received at the user interface (202) of the electronic device (200) at step 301 are administrative login credentials or administrative user credentials, or alternatively are user login credentials that allow less than administrative access to the electronic device (200), is determined by the one or more processors (204) of the electronic device (200), optionally in tandem with an authentication system (209), at decision 303.

At step 302, a location detector (210) of the electronic device (200) determines a location of the electronic device (200). In one or more embodiments, step 302 comprises the location detector (210) determining a login location of the electronic device (200) that occurs when the user login credentials are received by the user interface (202) at step 301. In another embodiment, step 302 comprises the location detector (210) determining an operating location of the electronic device (200) while the user login credentials are active.

Where the user credentials received at the user interface (202) of the electronic device (200) at step 301 allow less than administrative access to the electronic device (200), in one or more embodiments step 304 comprises the one or more processors (204) of the electronic device (200) precluding at least some access to content. For example, in one or more embodiments step 304 comprises the one or more processors (204) of the electronic device (200) precluding access to a content set comprising content created at the electronic device (200) and/or stored in the memory (205) of the electronic device (200) outside of a predefined radius of the location determined at step 302, which may be the login location, an operating location, or other location.

In one or more embodiments, step 304 comprises concealing one or more user actuation targets (229,230,231,232) linked to content created at the electronic device (200) or stored in the memory (205) of the electronic device (200) outside the predefined radius of the location of the electronic device (200) determined at step 302. In other embodiments, step 304 comprises disabling one or more user actuation targets (229,230,231,232) linked to content created at the electronic device or stored in the memory (205) of the electronic device (200) outside the predefined radius of the location of the electronic device (200) determined at step 302.

Step 305 then allows access to some content of the electronic device (200). For example, in one or more embodiments step 305 comprises making accessible, by the one or more processors (204) of the electronic device (200) at the user interface (202), only content created at the electronic device (200) or stored in a memory (205) of the electronic device (200) within a predefined radius of the location of the electronic device (200) determined at step 302. In other embodiments, step 305 can comprise making content created in the electronic device (200) within a predefined radius (the predefined radius may optionally be user-definable in the menu) of the location determined at step 302 accessible. In still other embodiments, step 305 can comprise precluding access, with the one or more processors (204), to a content set comprising content created at the electronic device (200) or stored in the memory (205) of the electronic device (200) outside the predefined radius of the location determined at step 302.

Embodiments of the disclosure contemplate that the electronic device (200) can move while the user login credentials remain operational. Accordingly, in one or more embodiments step 306 comprises monitoring, with the location detector (210), an operating location of the electronic device (200) while the user login credentials are active. Decision 307 comprises detecting, with the location detector (210) and/or location comparison engine (234), a change in the location of the electronic device (200).

In one or more embodiments, when decision 307 detects a change in the location of the electronic device (200), step 309 comprises precluding access to at least some content that was accessible prior to the move. For example, if the one or more processors (204) of the electronic device (200) made accessible, at step 305 prior to the change in location, only content created at the electronic device (200) or stored in a memory (205) of the electronic device (200) within a predefined radius of the location of the electronic device (200) determined at step 302, step 308 can comprise precluding access to at least a subset of that content after the change in location.

Alternatively, where step 304 comprises precluding access, with the one or more processors (204), to a second content set comprising content created at the electronic device (200) or stored in the memory (205) of the electronic device (204) outside the predefined radius of the login location identified at step 302, and decision 307 determines that the operating location moves outside the initial predefined radius, step 308 can comprise precluding access, with the one or more processors (205), to a fourth content set comprising content created at the electronic device (200) or stored in the memory (205) of the electronic device (200) outside another predefined radius of the new operating location, and so forth.

Step 309 is then the corollary of step 305, which provides access to certain content at the new location. For example, where step 305 comprises the one or more processors (204) of the electronic device (200) making accessible a first content set comprising content created at the electronic device (200) or stored in a memory (205) of the electronic device 200 within a predefined radius of the login location, and decision 307 determines that the operating location moves outside the initial predefined radius, step 309 can comprise making accessible, with the one or more processors (204), a third content set comprising content created at the electronic device (200) or stored in a memory (205) of the electronic device (200) within outside another predefined radius of the new operating location, and so forth.

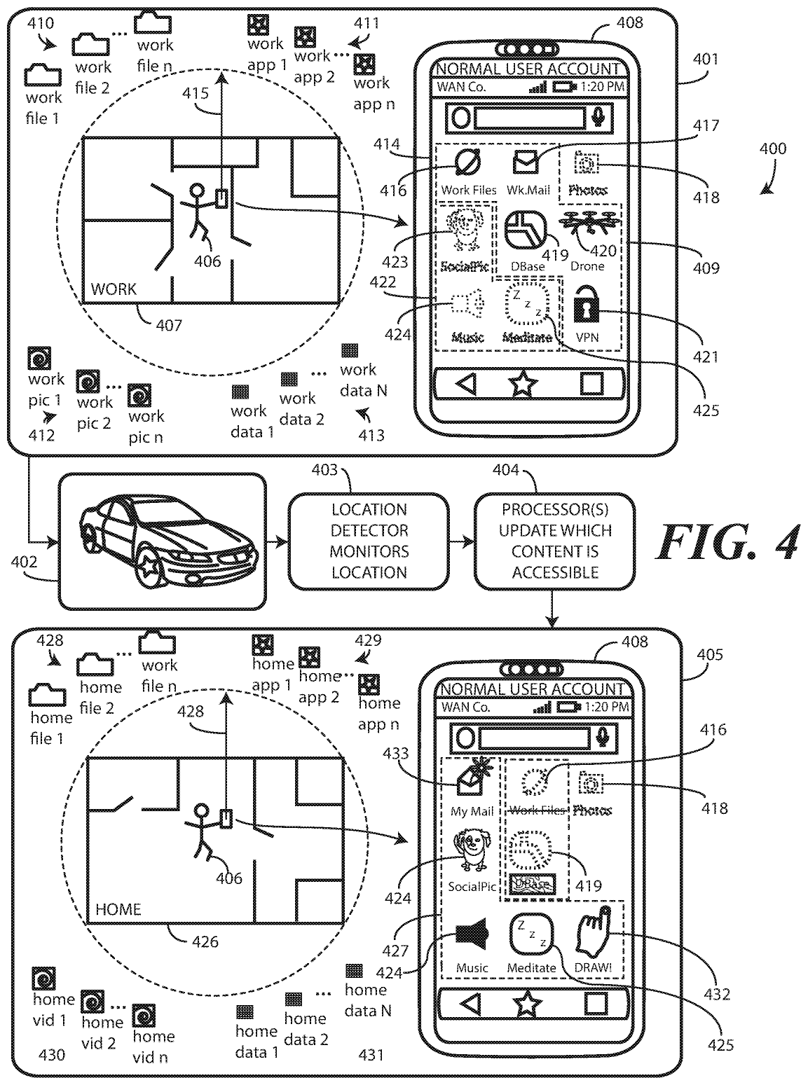

Turning now to FIG. 4, illustrated therein is another method 400 in accordance with one or more embodiments of the disclosure. Beginning at step 401, a user 406 is situated at work 407. The user 406 is operating an electronic device 408 after delivering user credentials allowing less than administrative access to the user interface 409 of the electronic device 408. In this example, the user 406 does not have administrative login credentials. Instead, the user 406 is a normal user with less than full access to the electronic device 408. The location detector of the electronic device 408 detects that the location of the electronic device 408 is the workplace. The location detector can do this in multiple ways, as noted above, including by accessing global positioning sensor data, triangulating terrestrial towers, triangulating WiFi access points or beacons, or other techniques.

As shown at step 401, there is a large amount of content that the user 406 has created with the electronic device 408 and/or stored in a memory of the electronic device 408, which may physically reside within the electronic device 408, be located in a cloud server or other device, or in a combination of the two. This content includes several work files 410 created in the electronic device 408 while the electronic device 408 was located at work 407, several applications 411 that were downloaded and/or installed to the electronic device 408 while at work 407, and data 413 used by the applications 411 that was created while the user 406 was at work.

Since the user 406 fails to have administrative login credentials, in one or more embodiments one or more processors of the electronic device 408, at step 401 the one or more processors of the electronic device 408 make a first content set 414 comprising content created at the electronic device 408 or stored in a memory of the electronic device 408 within a predefined radius 415 of the location where, in this example, both the user login credentials were entered and where the electronic device 408 is operating while the user login credentials are still active. Since the user 406 logged in at work 407 and has not left, work 407 defines both the login location and the operating location at step 401.

The first content set 414 includes a work files application 416 operable to access the work files 410, a work mail application 417, a database application 419 operable to access the data 413, a drone application 420 operable to fly one or more workplace drones, which constitute part of the user's job while at work 407, and a virtual private network application 421, which is one of the applications 411 downloaded and installed while the electronic device 408 was at work 407, which allows the user 406 to access the workplace servers.

At the same time, the one or more processors of the electronic device 408 preclude access to a second content set 422 comprising content created at the electronic device 408 or stored in a memory of the electronic device 408 outside the predefined radius 415 of the location identified by the location detector of the electronic device 408 at step 401. In this example, this content includes several applications that were downloaded and installed at the user's home, which is beyond the predefined radius 415 from the workplace. They include a social media application 423, which was installed while the user 406 was at home, a music player application 424, which came pre-installed on the electronic device 408 but that accesses music downloaded when the user 406 was at home, and a meditation application 425 that was also installed when the user 406 was at home.

In this illustrative example, the one or more processors preclude the access to the second content set 422 by disabling the user actuation targets linked to the second content set 422, which is indicated by the fact that these user actuation targets are shown in dashed line in FIG. 4. If the user 406 delivers user input requesting access to content in this second content set, e.g., if the user touches the social media application 423 in an attempt to launch it while at work 407, the one or more processors of the electronic device 408 would preclude access to the social media application 423 in response to this user input.

At step 402, the user 406 gets in a car and drives home, which is located more than the predefined radius 415 from the workplace. At step 403, the location detector of the electronic device 408 monitors the operating location of the electronic device 408 occurring while the user login credentials are active.

At step 404, since the user 406 has now moved more than the predefined radius 415 from work, the one or more processors of the electronic device 408 identify applications created at the electronic device 408 or stored in a memory of the electronic device 408 within a predefined radius of the operating location identified at step 403. For example, in one or more embodiments step 404 comprises the one or more processors of the electronic device 408 making a third content set accessible, where that third content set comprises content created at the electronic device 408 or stored in a memory of the electronic device 408 within a predefined radius of the operating location identified at step 403. Similarly, the one or more processors of the electronic device 408 could preclude access to a fourth content set comprising content created at or in the electronic device 408 or stored in a memory of the electronic device 408 outside the other predefined radius of the operating location detected at step 403 by the location detector of the electronic device 408.

For instance, at step 405 the user 406 has arrived at his home 425. At step 405 the one or more processors of the electronic device 408 make a third content set 427 comprising content created at the electronic device 408 or stored in a memory of the electronic device 408 within another predefined radius 428 of the home 426. In this example, the user login credentials were entered at work 407, but are still active when the user 406 arrives home 426. Since the user 406 logged in at work 407, but is now at home, work 407 defines the login location at step 401 and home 426 the operating location at step 405.

The third content set 427 includes a drawing application 432, which was one of several applications 429 downloaded at home 426 and operable to access the files 428 created at home 426, a personal mail application 433 that accesses personal mail data 431 from emails sent at home 426, the social media application 423, the music player application 424, and the meditation application 425 that was also one of the applications 429 installed when the user 406 was at home 426.

At the same time, the one or more processors of the electronic device 408 preclude access to another content set comprising content created at the electronic device 408 or stored in the memory of the electronic device 408 outside the other predefined radius 428 of the operating location. In this illustrative example, the one or more processors preclude access both by disabling user actuation targets linking to the content and concealing user actuation targets linked to the content. Illustrating by example, the user actuation target for the work file application 416 and the database application 419 have been disabled.

In this illustrative example, the one or more processors of the electronic device 408 have altered the available content and the other available content when the location of the electronic device 408 changes from work 407 to home 426. For instance, a visual indicator, shown as a line through “work files” for the user actuation target for the work file application 416 and an obfuscating box over “database” in the user actuation target for the database application 419, have been presented on the user interface 409 to alert the user 406 to the fact that these user actuation targets have been disabled. By contrast, the one or more processors of the electronic device 408 have concealed the user actuation target for the drone application 420, thereby making it invisible. Similarly, the one or more processors of the electronic device 408 have replaced the user actuation target for the virtual private network application 421 with the user actuation target of the drawing application 423.

Note that in this example there is photo browser application 418 that is precluded from access both at work 407 and at home 426. In one or more embodiments, this occurs because the user 408 has media content 412 created at work 407 and media content 430 created at home 426, each of which could be accessed by the photo browser application 418 if it were accessible.

Embodiments of the disclosure contemplate that having such an application accessible in the two locations, even though the data accessed by the application is different, can create problems. Proprietary and confidential work picture may be exposed at home 426, while controversial or personal videos may be exposed at work 407. Accordingly, in in this illustrative example, when an application or other content item is operable to access, process, or utilize data or other content in multiple locations, that application is simply precluded from access entirely. Such is the case with the photo browser application 418 in FIG. 4.

Said differently, in one or more embodiments the one or more processors of the electronic device 408 can identify a third content set comprising applications operable with both some content created at the electronic device 408 or stored in the memory of the electronic device 408 within the predefined radius 415 of the login location, e.g., the media content 412 created at work 407 in this example, and some other content created at the electronic device 408 or stored in the memory of the electronic device 408 outside the predefined radius of the login location, e.g., the media content 430 created at home 426, and can simply preclude access to such applications. In this example, such an embodiment would result in the photo browser application 418 being precluded from access both at home 426 and at work 407. For the user 406 to view the media content 412 created at work 407 and the media content 430 created at home 426, the user 406 in this case would need to use two different photo browser applications, i.e., one downloaded and installed at home 426 and another downloaded and installed at work 407.

Accordingly, in one or more embodiments the one or more processors of the electronic device 408 always preclude access to applications, e.g., the photo browser application 418, operable with first content created by the electronic device 408 or stored in the memory of the electronic device 408, e.g., media content 412, within the predefined radius 415 and second content, e.g., media content 430, created at the electronic device 408 or stored in the memory of the electronic device 408 beyond the predefined radius 415. Whether the electronic device 408 employs this embodiment or the embodiment originally described with reference to step 405 can be user-defined using one or more control settings in one or more embodiments.

Illustrating by example, in one or more embodiments the control settings could be set such that the photo browser application 418 is operable both at work 407 and at home 426. For instance, in another embodiment only the media content 412 created at work 407 would be accessible by the photo browser application 418 when the electronic device 408 is at work 407. Similarly, only the media content 430 created at home 426 would be accessible by the photo browser application 418 while the electronic device is at home 426. Other configurations to allow applications to be accessible in multiple locations, while accessing different data, will be obvious to those of ordinary skill in the art having the benefit of this disclosure.

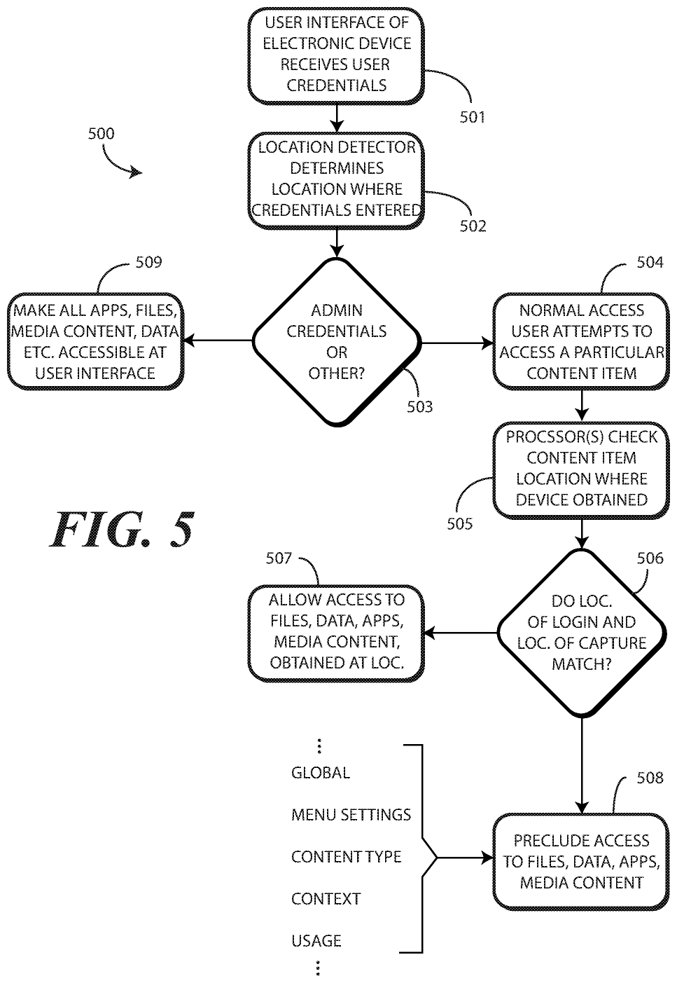

Turning now to FIG. 5, illustrated therein is another method 500 in accordance with one or more embodiments of the disclosure. Beginning at step 501, a user interface of an electronic device receives user credentials allowing less than administrative access to the electronic device. At step 502, a location detector of the electronic device determines a location of the electronic device. Decision 503 determines whether the user login credentials received at step 501 are administrative login credentials or other than administrative login credentials, which is the case in this illustrative example.

Had the user login credentials received at step 501 been the administrative login credentials, step 509 would have included making accessible all content created in the electronic device. However, since the user credentials allow less than administrative access to the electronic device in this example, step 504 comprises making only content created in the electronic device within a predefined radius of the location identified at step 502 available. Step 504 also comprises precluding access to other content created in the electronic device outside the predefined radius of the location identified at step 502.

If a user attempts to access the precluded content by delivering user input to a user interface of the electronic device attempting to actuate, enable, process, or otherwise access this precluded content, step 505 comprises the one or more processors accessing a content creation location database to determine a location where the content that is attempted to be accessed was created.

Decision 506 determines whether the content was created in the electronic device within the predefined radius of the location identified at step 502. The predefined radius can be user defined using one or more control settings of the electronic device. Examples of predefined radii a user might select include one hundred yards, one thousand yards, one mile, five miles, or ten miles. Other predefined radii will be obvious to those of ordinary skill in the art having the benefit of this disclosure.

Where it is, step 507 allows access to this content. However, where it is not, step 508 precludes access to the content. As noted above, this preclusion can be a function of global device settings, menu settings, the type of content to which access is being requested, context of the electronic device as determined by a context engine, or previous device usage by the user.

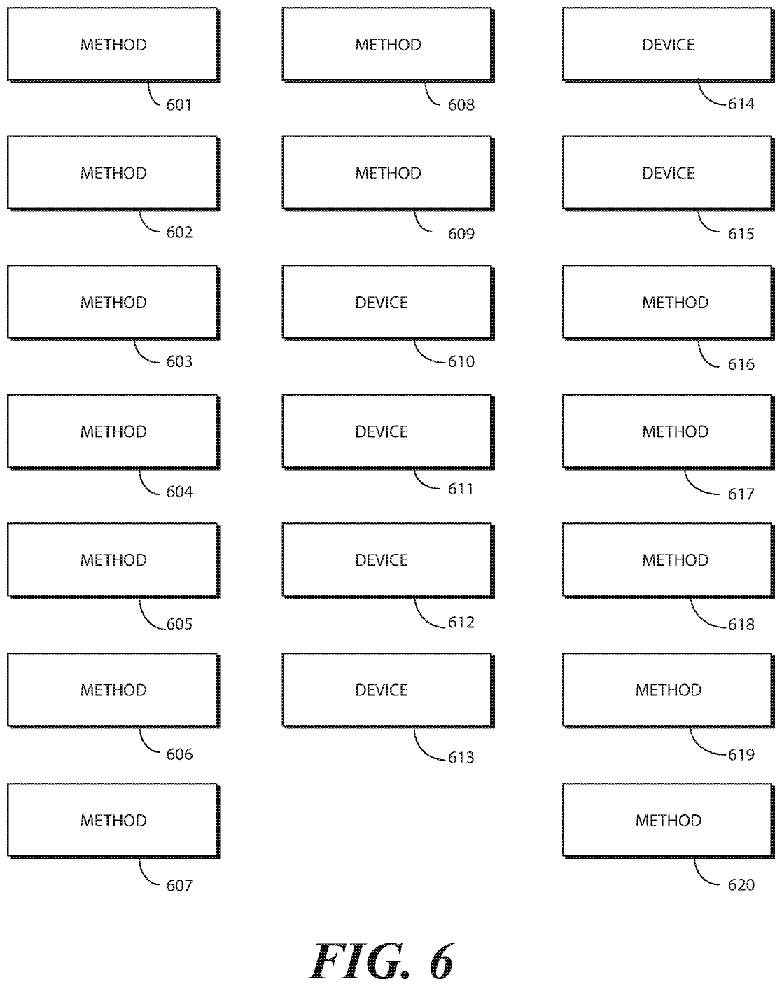

Turning now to FIG. 6, illustrated therein are various embodiments of the disclosure. The embodiments of FIG. 6 are shown as labeled boxes in FIG. 6 due to the fact that the individual components of these embodiments have been illustrated in detail in FIGS. 1-5, which precede FIG. 6. Accordingly, since these items have previously been illustrated and described, their repeated illustration is no longer essential for a proper understanding of these embodiments. Thus, the embodiments are shown as labeled boxes.

At 601, a method in an electronic device comprises receiving, at a user interface of the electronic device, user login credentials. At 601, the method comprises identifying, with a location detector, a login location of the electronic device occurring when the user login credentials are received.

At 601, the method comprises determining, with one or more processors operable with the user interface and the location detector, whether the user login credentials are administrative login credentials or user login credentials. At 601, and when the user login credentials are determined to be the user login credentials, one or more processors make accessible a first content set comprising content created at the electronic device or stored by the electronic device within a predefined radius of the login location and preclude access to a second content set comprising content created at the electronic device or stored by the electronic device outside the predefined radius of the login location.

At 602, the second content set of 601 comprises one or more of applications operable on the one or more processors, media content accessible at the user interface of the electronic device, files stored within the memory of the electronic device or accessible from a cloud server, data stored within the memory of the electronic device or accessible from a cloud server, social media content stored within the memory of the electronic device or accessible from a cloud server, or combinations thereof. At 603, when the user login credentials of 602 are determined to be the administrative login credentials, the one or more processors make the first content set and the second content set accessible.

At 604, the types of content included in one or both of the first content set or the second content set of 601 are user definable using one or more control settings of the electronic device. At 605, the precluding access to the second content set of 601 comprises concealing one or more user actuation targets linked to the second content set. At 606, the precluding access to the second content set of 601 comprises disabling one or more user actuation targets linked to the second content set.

At 607, the method of 601 further comprises monitoring, with the location detector, an operating location of the electronic device while the user login credentials are active. At 607, and when the operating location moves outside the predefined radius, the method of 601 further comprises making accessible, with the one or more processors, a third content set comprising content created at the electronic device or stored by the electronic device within another predefined radius of the operating location and precluding access, with the one or more processors, to a fourth content set comprising content created at the electronic device or stored by the electronic device outside the another predefined radius of the operating location.

At 608, the method of 601 further comprises identifying a third content set comprising applications operable with both some content created at the electronic device or stored by the electronic device within the predefined radius of the login location and some other content created at the electronic device or stored by the electronic device outside the predefined radius of the login location, and precluding access to the applications. At 609, the method of 601 further comprises receiving other user input at the user interface requesting access to second content set content, the precluding access to the second content set occurring in response to the other user input.

At 610, an electronic device comprises a user interface receiving user credentials. At 610, the electronic device comprises a location detector determining a location of the electronic device when the user credentials are received.

At 610, the electronic device comprises one or more processors determining whether the user credentials are administrative user credentials. At 610, and when the user credentials are other than the administrative user credentials, the one or more processors make content created in the electronic device within a predefined radius of the location accessible and preclude access to other content created in the electronic device outside the predefined radius of the location.

At 611, the one or more processors of 610 preclude access to the other content by concealing or locking user actuation targets linked to the other content. At 612, the one or more processors of 611 make the content accessible by revealing other user actuation targets linked to the content.

At 613, the one or more processors of 610 alter the content and the other content when the location of the electronic device changes. At 614, and when the user credentials are the administrative user credentials, the one or more processors of 613 make the content and the other content accessible. At 615, the one or more processors of 614 always preclude access to applications operable with both data created in the electronic device within the predefined radius and other data created in the electronic device outside the predefined radius when the user credentials are other than the administrative user credentials.

At 616, a method in an electronic device comprises receiving, at a user interface of the electronic device, user credentials allowing less than administrative access to the electronic device. At 616, the method comprises determining, with a location detector, a location of the electronic device. At 616, the method comprises making accessible, by one or more processors of the electronic device at the user interface, only content created at the electronic device or stored in a memory of the electronic device within a predefined radius of the location of the electronic device.

At 617, the method of 616 further comprises concealing one or more user actuation targets linked to other content created at the electronic device or stored in the memory of the electronic device outside the predefined radius of the location of the electronic device. AT 618, the method of 6161 further comprises disabling one or more user actuation targets linked to other content created at the electronic device or stored in the memory of the electronic device outside the predefined radius of the location of the electronic device.

At 619, the content of 616 comprises a first content subset and a second content subset. At 619, the method of 616 further comprises detecting, with the location detector, a change in the location of the electronic device and precluding, by the one or more processors at the user interface, access to the first content subset. At 620, the method of 616 further comprises always precluding, when the user credentials allow less than the administrative access to the electronic device, access to applications operable with first content created at the electronic device or stored in the memory of the electronic device within the predefined radius and second content created or stored in the memory beyond the predefined radius. In some embodiments, a user can, in the menu set rules to override. For example, the user might want gallery to not follow the capture/access mismatch restriction during normal access.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, at a user interface of the electronic device, user login credentials;
identifying, with a location detector, a login location of the electronic device occurring when the user login credentials are received;
determining, with one or more processors operable with the user interface and the location detector, whether the user login credentials are administrative login credentials or user login credentials; and
when the user login credentials are determined to be the user login credentials:
making accessible, with the one or more processors, a first content set comprising content created at the electronic device or stored by the electronic device within a predefined radius of the login location; and
precluding access, with the one or more processors, to a second content set comprising content created at the electronic device or stored by the electronic device outside the predefined radius of the login location.

2. The method of claim 1, wherein the second content set comprises one or more of applications operable on the one or more processors, media content accessible at the user interface of the electronic device, files stored by the electronic device or accessible from a cloud server, data stored within by the electronic device or accessible from the cloud server, social media content stored by the electronic device or accessible from the cloud server, or combinations thereof.

3. The method of claim 2, wherein when the user login credentials are determined to be the administrative login credentials, making accessible, with the one or more processors, the first content set and the second content set.

4. The method of claim 1, wherein types of content included in one or both of the first content set or the second content set are user definable using one or more control settings of the electronic device.

5. The method of claim 1, wherein the precluding access to the second content set comprises concealing one or more user actuation targets linked to the second content set.

6. The method of claim 1, wherein the precluding access to the second content set comprises disabling one or more user actuation targets linked to the second content set.

7. The method of claim 1, further comprising:
monitoring, with the location detector, an operating location of the electronic device while the user login credentials are active; and
when the operating location moves outside the predefined radius:
making accessible, with the one or more processors, a third content set comprising content created at the electronic device or stored by the electronic device within another predefined radius of the operating location; and
precluding access, with the one or more processors, to a fourth content set comprising content created at the electronic device or stored by the electronic device outside the another predefined radius of the operating location.

8. The method of claim 1, further comprising identifying a third content set comprising applications operable with both some content created at the electronic device or stored by the electronic device within the predefined radius of the login location and some other content created at the electronic device or stored by the electronic device outside the predefined radius of the login location, and precluding access to the applications.

9. The method of claim 1, further comprising receiving other user input at the user interface requesting access to second content set content, the precluding access to the second content set occurring in response to the other user input.

10. An electronic device, comprising:
a user interface receiving user credentials;
a location detector determining a location of the electronic device when the user credentials are received;
one or more processors determining whether the user credentials are administrative user credentials; and
when the user credentials are other than the administrative user credentials, the one or more processors:
making content created in the electronic device within a predefined radius of the location accessible; and
precluding access to other content created in the electronic device outside the predefined radius of the location.

11. The electronic device of claim 10, the one or more processors precluding access to the other content by concealing user actuation targets linked to the other content.

12. The electronic device of claim 11, the one or more processors making the content accessible by revealing other user actuation targets linked to the content.

13. The electronic device of claim 10, the one or more processors altering the content and the other content when the location of the electronic device changes.

14. The electronic device of claim 13, wherein when the user credentials are the administrative user credentials, the one or more processors make the content and the other content accessible.

15. The electronic device of claim 14, the one or more processors always precluding access to applications operable with both data created in the electronic device within the predefined radius and other data created in the electronic device outside the predefined radius when the user credentials are other than the administrative user credentials.

16. A method in an electronic device, the method comprising:
receiving, at a user interface of the electronic device, user credentials allowing less than administrative access to the electronic device;
determining, with a location detector, a location of the electronic device; and
making accessible, by one or more processors of the electronic device at the user interface, only content created at the electronic device or stored in a memory of the electronic device within a predefined radius of the location of the electronic device.

17. The method of claim 16, further comprising concealing one or more user actuation targets linked to other content created at the electronic device or stored in the memory of the electronic device outside the predefined radius of the location of the electronic device.

18. The method of claim 16, further comprising disabling one or more user actuation targets linked to other content created at the electronic device or stored in the memory of the electronic device outside the predefined radius of the location of the electronic device.

19. The method of claim 16, the content comprising a first content subset and a second content subset, further comprising:
detecting, with the location detector, a change in the location of the electronic device; and
precluding, by the one or more processors at the user interface, access to the first content subset.

20. The method of claim 16, further comprising always precluding, when the user credentials allow less than the administrative access to the electronic device, access to applications operable with first content created at the electronic device or stored in the memory of the electronic device within the predefined radius and second content created or stored in the memory beyond the predefined radius.
